(19) United States
(12) Patent Application Publication
(10) Pub. No.: US 2025/0192533 A1
(43) Pub. Date: Jun. 12, 2025

(54) OVERHEAD POWER CABLE SPACER DEVICE

(71) Applicant: ATP TRADING S.A.S., Envigado, Antioquia (CO)

(72) Inventors: Albeiro SERNA ARANGO, Envigado, Antioquia (CO); John Jairo ZAPATA GARCIA, Envigado, Antioquia (CO); Sebastián ZAPATA URIBE, Envigado, Antioquia (CO)

(21) Appl. No.: 18/843,939

(22) PCT Filed: Oct. 26, 2022
(86) PCT No.: PCT/IB2022/060303

§ 371 Date: Sep. 4, 2024

(30) Foreign Application Priority Data
Mar. 4, 2022 (CO) NC2022/0002621

(51) Int. Cl. H02G 7/12; H02G 1/02

(52) U.S. Cl. CPC H02G 7/12; H02G 1/02

(57) ABSTRACT

The present invention describes an overhead cable spacer device for coupling and keeping them separate from each other. The spacer device has a spacer body and at least four spacer arms coupled to the spacer body. Each of said at least four spacer arms includes an entering portion to receive the overhead cables and at least two retaining elements. One of said at least four spacer arms comprises a hole in its upper portion in which a mechanical rod is coupled in order for the spacer device to be installed from the ground, and a retaining element allows the coupling of the overhead cable, by means of pressure, and the other retaining element prevents the uncoupling of the overhead cable.

### FIELD OF INVENTION

The present invention relates in a general manner to electrical power distribution devices. More specifically, the present invention relates to spacer devices which are used to keep semi-insulated or ecological overhead electrical cables separate.

### BACKGROUND OF THE INVENTION

As is well known, the distribution of electrical energy, in several countries, is carried out by means of electrical networks comprising low, medium, or high voltage overhead lines or cables, which allows to distribute electrical energy over long distances to the different points of consumption. Depending on the voltage at which the energy is delivered, electrical networks are referred to as high, medium, or low voltage. That is, if the energy is delivered at voltages up to 1000 volts, it is classified as low voltage, while if it is delivered at between 1000 volts and 36,000 volts, it is classified as medium voltage and, finally, if it is delivered at between 36,000 volts and 230,000 volts, it is classified as high voltage. In addition, if said energy is delivered at voltages of more than 230,000 volts, it is classified as extra high voltage.

In the case of distribution in medium voltage electrical networks, these can be overhead or underground. When they are underground, the cable is insulated and shielded, and when the networks are overhead, the cable can be bare or semi-insulated (not shielded). Semi-insulated cable is also known as ecological cable because it is used in medium voltage overhead electrical networks to avoid electrical faults due to contact with trees, allowing the spacing in time of pruning periods.

In a medium voltage semi-isolated distribution network, four lines or cables are used, installed between poles; three of these cables are the conductor lines for the three phases (three-phase system) and the fourth line is the neutral cable, which simultaneously serves as a guard cable and as a messenger cable or support cable for the system.

Due to the amounts of energy that are delivered, there are different problems in the medium voltage overhead lines or cables. Another of the most trivial problems is the contact of these conductor lines or cables with each other, generating short circuits and, therefore, stopping the operation of the electric power distribution network.

To solve this problem, numerous devices have been used to separate the cables from each other, preventing contact between them. However, the installation of such spacer devices is problematic due to the time involved and the associated high costs.

An improvement that is disclosed in the present invention consists in the installation of the overhead cable spacer device from the floor, by means of a mechanical rod or, colloquially called, pole. When performing an installation from the ground, it could complicate the coupling of the conductor cables to the arms of the spacer device, however, the present invention incorporates retaining elements where, by means of pressure applied to them, the conductor cable enters the arm without major effort. The foregoing provides a spacer device of easy installation from the ground and, in addition, of easy coupling to the conductor cables, without the need to use bucket trucks or persons in close contact with the spacer device and the conductor cables.

A clear example of prior art disclosing spacer devices is the one disclosed in U.S. Pat. No. 9,022,357B2, which shows an aerial roller spacer and methods of installation thereof. Said roller spacer comprises a body, seats that are formed in the body, an arm connected to the body at a first end, wherein the arm extends away from the body. A roller assembly is positioned proximate to a second end of the arm, wherein the roller assembly has two rotatable roller halves that can be removably engagable with one another with at least one fastener. A messenger groove is formed between the two rotatable roller halves.

The above spacer device has the disadvantage of not mentioning its way of installation. That is, nothing is disclosed regarding whether it is installed from the floor or by means of a bucket truck. In addition, the coupling of the conductor cables is made through ratchet arms or a similar structure, which may entail more installation time and may be complicated if attempted from the floor due to the manual locking of each of the ratchets.

On the other hand, U.S. patent application U.S. Pat. No. 3,300,576A, discloses a spacer for aerial cable comprising a central, vertical, generally round arm having similar side arms mounted thereon and that extend therefrom, in opposite parallel directions. The central vertical arm extends upwardly of the side arms and terminates thereabove in a hook for coupling to the guard cable.

One of the inconsistencies in the above mentioned prior art lies in the fact that the coupling of the conductor cables is by means of anchorage of the type of elastic bands or similar, which is complicated if it is attempted to be performed from the floor. That is to say, due to this complication the coupling of the conductor cables must be performed manually by a person.

On the other hand, U.S. Pat. No. 2,934,587A discloses an aerial cable spacer comprising a unitary member defining a substantial closure around a space, wherein said closure comprises a plurality of cable member receiving seats, and an access slot. This document does disclose that the coupling of the conductor cables is by means of retaining elements, however, the document does not disclose anything with respect to whether it is installed from the floor or by means of a bucket truck.

Another relevant document found in the prior art is Canadian patent application CA757230A, which relates to a spacer for aerial cable comprising a central, vertical, generally round arm mounting similar side arms which extend therefrom, in opposite parallel directions. The central vertical arm extends upwardly of the side arms and terminates thereabove in a hook for coupling with the guard cable. This document does disclose that the spacer comprises a hole in the central vertical arm of the guard cable that can be used for installation from the floor. However, in said prior art document the conductor cables are coupled by means of anchorage of the type of elastic bands or similar, which is complicated if it is attempted to be performed from the floor. That is to say, due to this complication the coupling of the conductor cables must be performed manually by a person.

Next, Mexican patent MX280294B focuses on an aerial cable spacer with a cable retainer and vertically positioned reinforcing tabs or ribs. The cable retainer includes a cable retainer arm. A middle portion of the cable retainer arm has a non-rectangular “+” cross section. The non-rectangular “+” cross section is coupled and exerts a force on the cable as the cable retainer arm flexes to a closed position. The arm is flexible to create an elastic force in conjunction with the non-rectangular “+” cross section and to securely hold the cable over a cable seat of a main upper portion of the cable spacer. A nail is ported on the arm with a predetermined orientation, the foregoing to be coupled with a corresponding set of teeth on the spacer body and to improve the clapming force of the cable.

The above spacer device has the disadvantage of not mentioning its way of installation. That is, as mentioned with respect to the deficiencies of the prior art, nothing is disclosed regarding whether it is installed from the floor or by means of a bucket truck. In addition, the coupling of the conductor cables is made through ratchet arms or a similar structure, which may entail more installation time and may be complicated if attempted from the floor due to the manual locking of each of the ratchets.

On the other hand, U.S. patent application U.S. Pat. No. 9,444,240B2 discloses an aerial cable spacer apparatus and methods associated thereof. The aerial cable spacer apparatus includes a spacer arm. A spacer body is connected to the spacer arm. At least one saddle is formed on the spacer body. At least one roller is connected to at least one of the at least one saddle and the spacer body, wherein an exterior surface of the at least one roller is positioned to intersect a cable interface path of the at least one saddle.

The above spacer device, although featuring a hole in its lower portion, does not disclose anything regarding whether it is installed from the floor or by means of a bucket truck. Moreover, similarly to several of the mentioned documents, the coupling of the conductor cables is made through ratchet arms or a similar structure, which may entail more installation time and may be complicated if attempted from the floor due to the manual locking of each of the ratchets.

Finally, the Brazilian patent document BR8202755U mentions a spacer composed of a vertical rod structured with supports made of weather-resistant polymeric material and, in the form of a single integral body with a progressive compression locking system, to promote the spacing and fixation of overhead electric power conductor cables of different diameters.

The Brazilian document discloses a progressive compression locking system, which works inversely to the ratchet arms, allowing an easier installation of the conductor cables, however, there is no mention regarding the installation of said spacer from the floor. In addition, it discloses that the body of the spacer is vertical, unlike that of the present invention which is cross-shaped.

Considering the defects of the prior art, an object of the present invention is to separate the conductor cables from each other by means of retaining elements where, when pressure is applied to them, the conductor cables enter each of the arms of the spacer device without major effort. The foregoing also allows the installation of said device from the floor in a fast, easy, efficient, and inexpensive manner.

### BRIEF DESCRIPTION OF THE INVENTION

The present invention relates to a medium voltage overhead cable spacer device, comprising a spacer body and at least four spacer arms coupled to said spacer body. Each of said at least four spacer arms is hook-shaped and is formed to comprise an entering portion for receiving either the conductor cable or the guard cable. Furthermore, each of said at least four spacer arms comprises at least two retaining elements, which, by means of pressure applied to them, allow the coupling of the conductor cables without major effort.

It is important to mention that one of said at least four spacer arms is coupled to the guard cable and comprises a hole in its upper portion, which allows the reception of a mechanical rod or, colloquially called, pole for the overhead cable spacer device to be installed from the ground.

Other objects, advantages, and novel aspects of the invention will be evident from the following detailed description together with the accompanying drawings.

### BRIEF DESCRIPTION OF THE DRAWINGS

The aspects that are considered characteristic of the present invention will be set forth with particularity in the appended claims. However, the invention itself, regarding its organization and method of operation, together with other objects and advantages thereof, will be better understood in the following description, when read in relation to the accompanying drawings, wherein:

FIG. 1 is a plan view in front elevation showing a preferred embodiment of an overhead cable spacer device of the present invention.

FIG. 2 is a detail view of one of the spacer arms of the overhead cable spacer device of the present invention.

FIG. 3 is a right front perspective view showing the overhead cable spacer device coupled to the medium-voltage overhead cables, in accordance with the preferred embodiment of the present invention.

### DETAILED DESCRIPTION OF THE INVENTION

The present invention is illustrated with reference to a medium voltage overhead cable spacer device having a particular configuration and particular characteristics, the present invention is not limited to this configuration or those characteristics, and other configurations and characteristics may be used.

Similarly, the description of the present invention is detailed and accurate to allow those skilled in the art to be able to reproduce the invention, the invention may be presented or incorporated into other structures in addition to the illustrative structure shown. The scope of the invention is defined in the claims appended hereto.

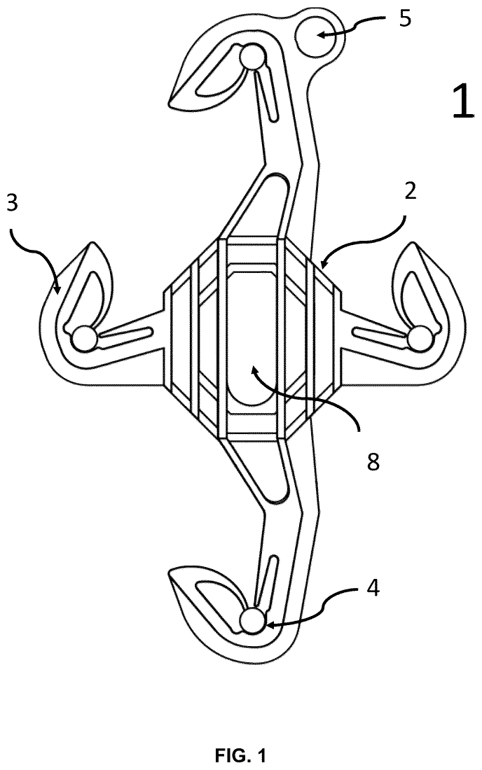

Referring to FIG. 1, the preferred embodiment of the overhead cable spacer device 1 of the present invention is shown, which features elements capable of coupling and keeping medium voltage cables spaced apart from each other. The overhead cable spacer device 1 comprises a spacer body 2 and at least four spacer arms 3 coupled thereto. Three of said at least four spacer arms 3 comprise an entering portion 4 for receiving the conductor cables, while one of said at least four spacer arms 3 comprises an entering portion 4 for receiving the guard cable. It is of utmost importance to mention that said one of said at least four spacer arms 3 comprises a hole 5 in its upper part, which allows the reception of a mechanical rod or, colloquially called, pole for the overhead cable spacer device 1 to be installed from the floor.

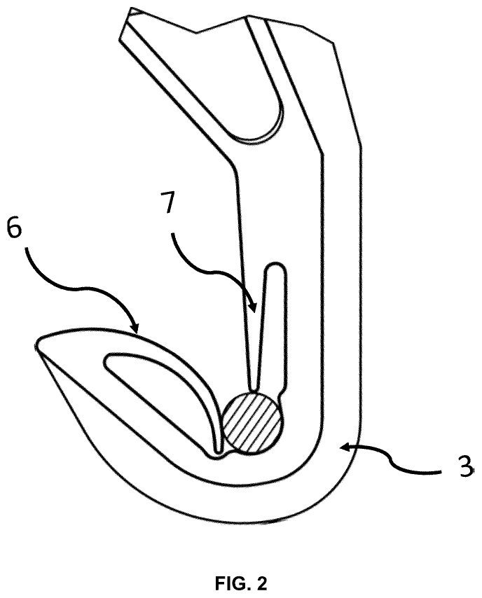

With respect to FIG. 2, a close-up of one of said at least four spacer arms 3 is shown, which, in order to achieve coupling and keeping the medium voltage cables separated from each other, comprises at least two retaining elements 6 and 7. In a preferred embodiment, each of said at least four spacer arms 3 comprises at least two retaining elements 6 and 7.

Returning to FIG. 1, in a preferred embodiment, both the spacer body 2 and said at least four spacer arms 3 comprise a hollow structure 8 to reduce the weight of the overhead cable spacer device 1. That is, having a hollow structure 8 allows the easy installation of the overhead cable spacer device 1 from the floor to the medium voltage cables.

In a preferred embodiment, said hollow structure 8 is made of high-density polyethylene, which prevents short circuits caused by the conductor cables.

In a preferred embodiment, each of said at least four spacer arms 3, is hook-shaped.

In a preferred embodiment, the entering portion 4 of each of said at least four spacer arms 3 has the shape of a semicircle, which allows the cables to be held in said entering portion 4 regardless of the gauge of the cables.

### Method of Installation of the Overhead Cable Spacer Device 1:

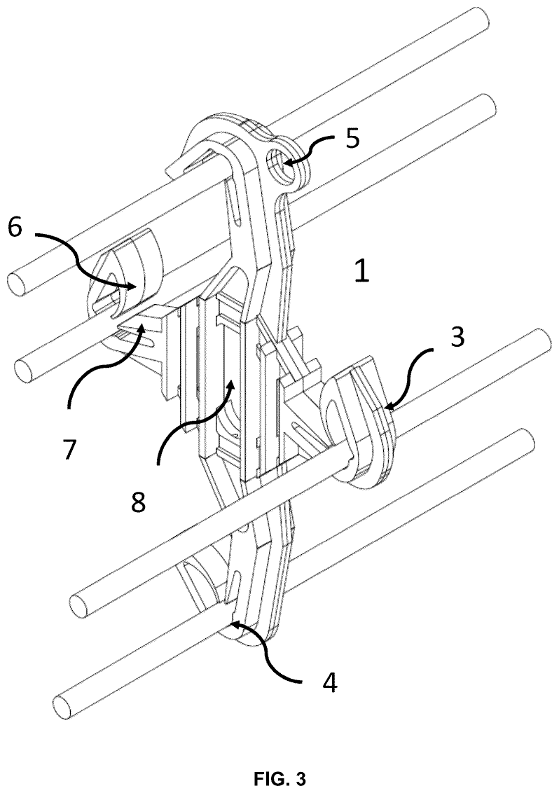

FIG. 3 shows a preferred mode of installation of the medium voltage cables on the overhead cable spacer device 1. In order to install the overhead cable spacer device 1 of the present invention, a mechanical rod or, colloquially called, pole, which is coupled to the hole 5 of one of said at least four spacer arms 3, is needed. Once the mechanical rod is coupled to the hole 5, said one of said at least four spacer arms 3 is positioned, manually, on the guard cable. When positioning the guard cable between said at least two retaining elements 6 and 7, one retaining element 6 of said at least two retaining elements is pressed into said one of said at least four spacer arms 3, allowing entry and, therefore, the coupling of the guard cable to said entering portion 4, while the other retaining element 7 of said at least two retaining elements prevents the uncoupling of the guard cable once inserted into said entering portion 4.

Once the guard cable is installed in the overhead cable spacer device 1, the mechanical rod is uncoupled from the hole 5 to install the remaining conductor cables in each of said at least three remaining spacer arms 3. That is, now the mechanical rod is used to manipulate one of the conductor cables and position it between said at least two retaining elements 6 and 7 of one of said at least three remaining spacer arms 3. As mentioned above, a retaining element 6 of said at least two retaining elements is pressed into the selected spacer arm 3, allowing the entry and, therefore, the coupling of the conductor cable to the entering portion 4, while the other retaining element 7 of said at least two retaining elements, prevents the uncoupling of the conductor cable once inserted into the entering portion 4. In the same way, the remaining conductor cables are installed in the remaining spacer arms 3.

Thus, an overhead cable spacer device 1 with the following novel technical characteristics is disclosed:
Installation from the ground, thanks to the coupling of a mechanical rod on the overhead cable spacer device 1; and
Coupling of the medium voltage cables, thanks to retaining elements.

The aforementioned is carried out manually without major effort.

### Novelty of the Invention

Having described the present invention as above, it is considered as a novelty and, therefore, it is claimed as proprietary the contents of the following.

1. An overhead cable spacer device for coupling and keeping overhead cables separate from each other, characterized in that it comprises:
a spacer body; and
at least four spacer arms coupled to the spacer body, wherein each of said at least four spacer arms comprises:
an entering portion for receiving the medium voltage cables; and
at least two retaining elements;
wherein one of said at least four spacer arms comprises a hole in its upper portion into which a mechanical rod is attached for the overhead cable spacer device to be installed from the floor; and
wherein a retaining element allows the coupling of the overhead cable, by means of pressure, and the other retaining element prevents the uncoupling of the overhead cable.

2. The spacer device according to claim 1, characterized in that the spacer body and said at least four spacer arms comprise a hollow structure.

3. The spacer device according to claim 2, characterized in that the hollow structure allows the easy installation of the overhead cable spacer device from the floor to the overhead cables.

4. The spacer device according to claim 2, characterized in that the hollow structure is manufactured using high-density polyethylene.

5. The spacer device according to claim 1, characterized in that the entering portion of each of said at least four spacer arms has the shape of a semicircle.

6. The spacer device according to claim 1, characterized in that each of said at least four spacer arms is hook-shaped.
